(19) United States
(12) Patent Application Publication
(10) Pub. No.: US 2004/0247268 A1
(43) Pub. Date: Dec. 9, 2004

(54) Optical imaging system

(75) Inventors: Yasushige Ishihara, Tokyo (JP); Akihiro Horii, Tokyo (JP)

Correspondence Address: SCULLY SCOTT MURPHY & PRESSER, PC, 400 GARDEN CITY PLAZA, GARDEN CITY, NY, 11530

(73) Assignee: OLYMPUS CORPORATION, TOKYO (JP)

(21) Appl. No.: 10/823,833

(22) Filed: Apr. 14, 2004

(30) Foreign Application Priority Data
Apr. 18, 2003 (JP) 2003-114805

(51) Int. Cl. G02B 6/06

(52) U.S. Cl. 385/117

(57) ABSTRACT

The present invention provides an optical imaging system including: a light source for emitting light to a sample; a small-diameter probe; a fiber optic bundle, arranged in the probe, for guiding light from the light source to the sample; a photodetector for detecting light reflected by the sample; an image generating circuit for generating an image on the basis of signals obtained by the photodetector; a connecting member for detachably connecting the probe to at least one of the light source, the photodetector, and the image generating circuit; and a position adjustment mechanism for adjusting the relative positional relation between the end face of the fiber bundle close to the light source and light, which is emitted from the light source and is incident on the fiber bundle.

This application claims benefit of Japanese Application No. 2003-114805 filed on Apr. 18, 2003, the contents of which are incorporated by this reference.

### BACKGROUND OF THE INVENTION

1. Field of the Invention

The present invention relates to an optical imaging system for obtaining a microscope image using a fiber optic bundle.

2. Description of Related Art

As a conventional microscope capable of obtaining a microscope image of a subject, Japanese Unexamined Patent Application Publication No. 11-84250 discloses a confocal microscope with an optical fiber. The confocal microscope is constructed such that optical scanning means is provided for the distal end of the optical fiber and the means optically scans a subject.

The conventional microscope uses the optical fiber and requires optical scanning means at the distal end of the fiber. Accordingly, the distal end of the fiber is thick.

As another conventional microscope for obtaining a microscope image of a sample using a fiber optic bundle, Japanese Unexamined Patent Application Publication No. 11-133306 discloses a confocal microscope.

The latter microscope uses the fiber optic bundle. Optical scanning means can be arranged at the proximal end of the fiber optic bundle. Accordingly, it is unnecessary to arrange optical scanning means at the distal end of the bundle.

### SUMMARY OF THE INVENTION

The present invention provides an optical imaging system including: a light source for emitting light to a sample; a small-diameter probe; a fiber optic bundle, arranged in the probe, for guiding light from the light source to the sample; a photodetector for detecting light reflected by the sample; an image generating circuit for generating an image on the basis of signals obtained by the photodetector; connecting means for detachably connecting the probe to at least one of the light source, the photodetector, and the image generating circuit; and a position adjustment mechanism for adjusting the relative positional relation between the end face of the fiber bundle close to the light source and light, which is emitted from the light source and is incident on the fiber bundle.

### BRIEF DESCRIPTION OF THE DRAWINGS

FIG. 1 is a schematic diagram of the entire structure of an optical imaging system according to a first embodiment of the present invention;

FIG. 2 is a diagram of the internal structure of the optical imaging system according to the first embodiment;

FIG. 3 is a sectional view of the structure of the distal end of an optical probe according to a modification of the first embodiment;

FIG. 4A is a block diagram showing the structure of a main body having a mechanism for adjusting a lens position relative to a connector according to a second embodiment;

FIG. 4B is a diagram explaining the positional relation between the connector and a converging lens;

FIG. 5 is a flowchart explaining the operation of an automatic stage adjustment device in FIG. 4;

FIG. 6 is a diagram explaining a mechanism for manually adjusting a focal point along an optical axis;

FIG. 7A is a sectional view explaining a mechanism for adjusting a position in a plane orthogonal to the optical axis;

FIG. 7B is a front view explaining the mechanism for adjusting a position in the plane orthogonal to the optical axis;

FIGS. 8A and 8B are diagrams briefly explaining a principle of electrically adjusting a position in the plane;

FIG. 8A shows a state of the arrangement of optical fibers at a fiber end face;

FIG. 8B shows a state of optical scanning at the fiber end face through scan mirrors 24a and 24b and shows an output range in the x and y directions of a photodetector 29 in the optical scanning;

FIGS. 9A to 9F are charts explaining an illustration of the adjustment operation for display of a portion where the optical fibers exist;

FIG. 9A is a waveform chart of a frame trigger signal serving as a trigger in low-speed scanning, namely, scanning in the y direction in a concrete example;

FIG. 9B is a waveform chart showing a state in which reflected light is detected (shown at a level H) in a portion including the fiber end face in optical scanning in the y direction (low-speed scanning) synchronized with a frame trigger;

FIG. 9C is a waveform chart of a line trigger signal in optical scanning in the x direction (high-speed scanning);

FIG. 9D is a waveform chart showing a state in which reflected light is detected in a portion including the fiber end face;

FIG. 9E is a diagram showing a scanning range, which is wider than the portion including the fiber end face and includes a region where reflected light is detected;

FIG. 9F is a diagram showing a display range;

FIGS. 10A to 10H are diagrams explaining the operation of adjusting a scanning range to only a portion where the optical fibers exist;

FIG. 10A shows a scanning range in scanning before automatic adjustment;

FIG. 10B shows a vibration waveform of each mirror in the case of FIG. 10A;

FIG. 10C shows a trigger signal in the case of FIG. 10A;

FIG. 10D shows a signal of light reflected from the fiber end face in the case of FIG. 10A;

FIG. 10E shows a scanning range after the automatic adjustment;

FIG. 10F shows a vibration waveform of each mirror in the case of FIG. 10E;

FIG. 10G shows a trigger signal in the case of FIG. 10E;

FIG. 10H shows a signal of light reflected from the fiber end face in the case of FIG. 10E;

FIG. 11 is a diagram showing optics in the vicinity of a connector attached to a main body according to a third embodiment of the present invention;

FIGS. 12A to 12C are diagrams showing the relation between the size of each core 61 and that of each cladding 62 in a fiber optic bundle 7 used in the third embodiment;

FIG. 12A is a schematic diagram showing the size of the core 61 and that of the cladding 62 in the fiber optic bundle 7 with emphasis on crosstalk (resolving power);

FIG. 12B is a schematic diagram showing the size of the core 61 and that of the cladding 62 in the fiber optic bundle 7 in consideration of both crosstalk and optical efficiency (S/N ratio);

FIG. 12C is a schematic diagram showing the size of the core 61 and that of the cladding 62 in the fiber optic bundle 7 with emphasis on the optical efficiency;

FIG. 13 is a sectional view showing the structure of the distal end of an optical probe according to the third embodiment;

FIG. 14 is a sectional view showing the structure of the distal end of an optical probe according to a first modification of the third embodiment;

FIG. 15 is a sectional view showing the structure of the distal end of an optical probe according to a second modification of the third embodiment;

FIG. 16 is a sectional view showing the structure of the distal end of an optical probe according to a third modification of the third embodiment;

FIG. 17 is a sectional view showing the structure of the distal end of an optical probe according to a fourth modification of the third embodiment;

FIGS. 18A and 18B are diagrams showing the structure of the distal end of an optical probe according to a fourth embodiment;

FIG. 18A is a sectional view showing the structure of the distal end of the optical probe according to the fourth embodiment;

FIG. 18B is a perspective view of a hollow needle of the optical probe;

FIG. 19A is a sectional view showing the structure of the distal end of an optical probe 10 according to a first modification of the fourth embodiment;

FIG. 19B is a sectional view of a needle portion 11a inserted in a sample 2;

FIGS. 20A and 20B are diagrams explaining the structure of the distal end of an optical probe 3 according to a second modification of the fourth embodiment;

FIG. 21 is a diagram showing optics in a main body and an optical probe according to a fifth embodiment of the present invention;

FIG. 22 is a diagram showing essential components, namely, optics of an optical imaging system 83 and an optical probe according to a modification of the fifth embodiment;

FIG. 23A is a diagram showing the structure of an optical imaging system 91 according to a sixth embodiment;

FIG. 23B is a diagram explaining the distal end of an endoscope and the vicinity thereof in a use example; and

FIG. 24 is a diagram of the entire structure of an optical imaging system according to a modification of the sixth embodiment.

### DETAILED DESCRIPTION OF PREFERRED EMBODIMENTS

Embodiments of the present invention will now be described hereinbelow with reference to the drawings.

(First Embodiment)

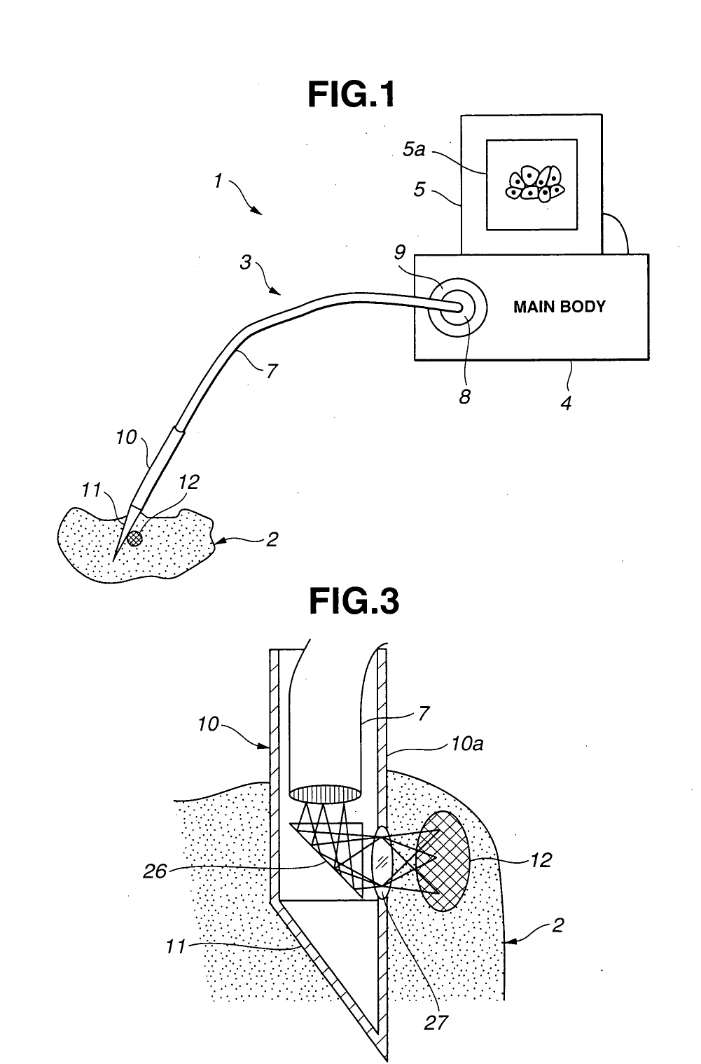

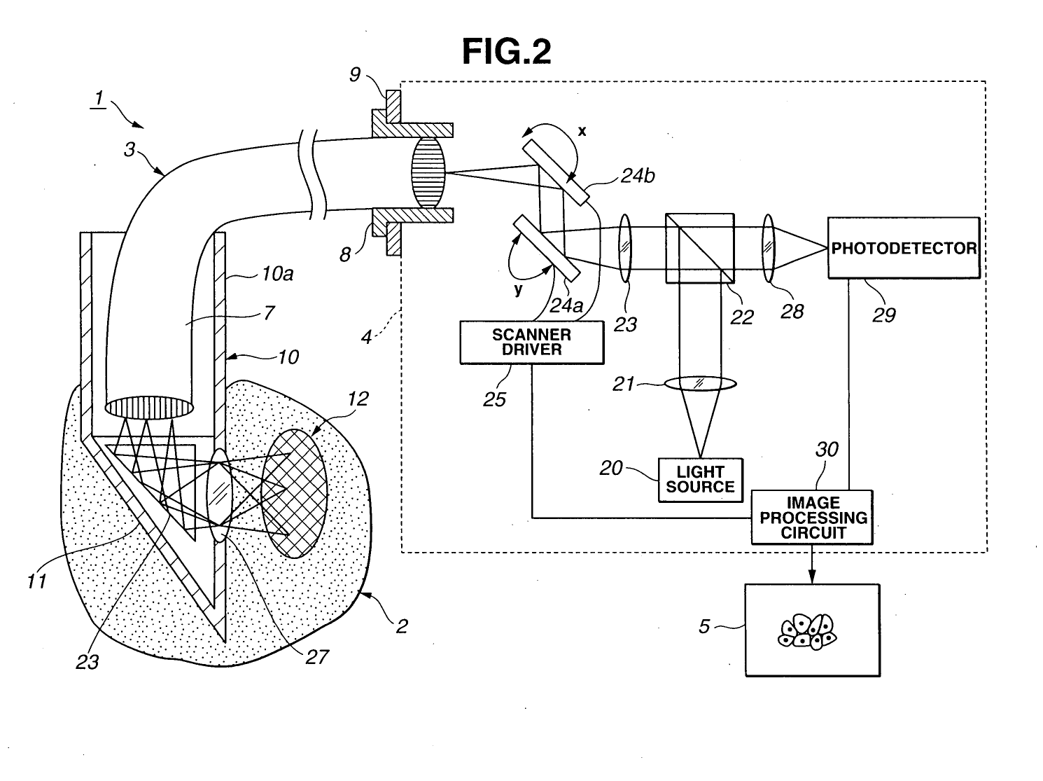

FIGS. 1 and 2 relate to a first embodiment of the present invention. FIG. 1 is a diagram explaining the schematic structure of an optical imaging system according to the first embodiment. FIG. 2 is a diagram explaining the internal structure of the optical imaging system according to the first embodiment.

Referring to FIG. 1, according to the first embodiment of the present invention, an optical imaging system 1 includes a long and thin optical probe 3 through which a sample 2 is microscopically observed, a main body 4 to which the optical scanning probe 3 is detachably connected, and a monitor 5, connected to the main body 4, for displaying a microscope image generated by image generating means in the main body, specifically, a cell image 5a of tissue of the sample 2.

The optical probe 3 includes a flexible tube and a small-diameter fiber optic bundle 7 arranged therein. The optical probe 3 has an insertion portion capable of being inserted into a body cavity. A connector 8 serving as connecting means is provided for the proximal end of the optical probe 3. The connector 8 is detachably connected to a connector receptacle 9 provided for the main body 4.

The optical probe 3 has a rigid end 10 at the distal end thereof. A sharp needle portion 11 is formed at the end of the distal end 10 so that the end of the distal end 10 can be inserted into the sample 2. Thus, a desired portion inside the sample 2 can be observed as an observation range 12 (refer to FIG. 2).

Referring to FIG. 2, the main body 4 has therein a light source 20 such as a semiconductor laser. Light from the light source 20 passes through a collimator lens 21, so that a collimated beam is generated. After that, a half mirror 22 serving as light separating means reflects a part of the beam. The separated beam is converged by a converging lens 23. The half mirror 22 has a function of guiding light from the light source 20 to the converging lens 23 and a function of isolating light reflected from the sample 2 to a photodetector 29 when the reflected light is incident on the half mirror 22 through the converging lens 23. In fluorescence observation, which will be described later, a dichroic mirror is used instead of the half mirror 22. The dichroic mirror also serves as light isolating means.

Scan mirrors 24a and 24b serving as optical scanning means are arranged on an optical path on which light is converged by the converging lens 23. A scanner driver 25 electrically drives the scan mirrors 24a and 24b, so that the scan mirrors 24a and 24b move the light, converged through the converging lens 23, in the y and x directions perpendicular to the optical axis of the converging lens 23. The scan mirrors 24a and 24b move the light over the proximal end face of the fiber optic bundle 7 fixed to the connector 8 arranged at the end of the optical probe 3 close to the light source, namely, at the proximal end of the optical probe 3, thus changing an irradiation position.

In other words, the proximal end face of the fiber optic bundle 7 is fixed in the connector 8. At the end face, many optical fibers are arranged such that they are aligned in the x and y directions. The connector 8 is attached to the connector receptacle 9 on the main body 4 such that the proximal end face of the fiber optic bundle 7 is positioned in nearly the focal plane of the converging lens 23.

Therefore, the scanning light two-dimensionally scans over the end faces of the respective optical fibers, which are two-dimensionally aligned in the fiber optic bundle 7. In the following description, it is assumed that the cross section of the fiber optic bundle 7 is a circle.

For example, while the scanner driver 25 allows the scan mirror 24a to scan in the y direction orthogonal to the optical axis of the converging lens 23 in a predetermined range (which is larger than the diameter of the proximal end face of the fiber optic bundle 3), namely, for a scanning period of one frame, the scanner driver 25 allows the scan mirror 24b to repetitively scan in the x direction perpendicular to the y direction in a predetermined range (that is larger than the diameter of the end face of the fiber optic bundle 3) at high speed.

The optical fibers transmit, namely, guide the incident light to the distal end face of the optical probe 3.

A part of the optical probe 3 includes the flexible tube to cover, namely, protect the fiber optic bundle 7. Accordingly, the optical probe 3 is flexible. The optical probe 3 has the rigid end 10 at the distal end. The distal end of the fiber optic bundle 7 is fixed in the rigid end 10. The rigid end 10 has therein optics for converging light guided through the fiber optic bundle 7 and emitting the light to the sample 2.

Light emitted from the distal end face of the fiber optic bundle 7 is reflected to one side by a prism 26 arranged in the needle portion 11. The reflected light is converged by a converging lens 27 having a large numerical aperture. The converging lens 27 is disposed in an opening on the side of the needle portion 11 so as to face one side face of the prism 26. The converged light is applied to a portion facing the converging lens 27.

Referring to FIG. 2, the needle portion 11 is formed such that the end of a tubular member 10a serving as an exterior tube of the end 10 is cut obliquely and the cut face is closed. The needle portion 11 has a shape that is easily insertable into the sample 2.

As shown in FIG. 2, inserting the needle portion 11 into the sample 2 enables optical scanning for a portion, which faces the converging lens 27 and serves as the observation range 12.

In this case, the light from the light source 20 is incident on the proximal end face of the fiber optic bundle 7 through the converging lens 23 and the scan mirrors 24a and 24b in the main body 4 while two-dimensionally scanning over the optical fibers aligned two-dimensionally. Thus, the light emitted from the distal end face of the fiber optic bundle 7 two-dimensionally shifts at the distal end face. The emitted light is incident on the prism 26 and the converging lens 27 while the emitting position is being shifted.

FIG. 2 shows three typical optical paths of light emitted from the distal end face of the fiber optic bundle 7. A position irradiated by the converged light is changed depending on the position of light emitted from the distal end face of the fiber optic bundle 7.

In this case, the converging lens 27 converges light emitted from the distal end faces of the respective optical fibers at the distal end face of the fiber optic bundle 7 to the observation range 12, the distal end face and the observation range 12 being conjugate focal points only light reflected or scattered at the converging point is incident on the optical fibers through the converging lens 27.

The light incident on the optical fibers is transmitted in the reverse direction and is then emitted from the proximal end face of the optical probe 3. The emitted light is transmitted through the scan mirrors 24b and 24a and the converging lens 23, thus producing a collimated beam. The beam is incident on the half mirror 22. A part of the beam passes through the half mirror 22. After that, the beam is converged by a converging lens 28. The converged light is received by the photodetector 29.

A light receiving face of the photodetector 29 is pinhole-shaped. The photodetector 29 receives only light in the vicinity of the focal point of the converging lens 28. The photodetector 29 converts received light into electric signals. The electric signals are supplied to an image processing circuit 30.

The image processing circuit 30 serves as image generating means. The image processing circuit 30 amplifies signals supplied from the photodetector 29, converts analog signals into digital data, and stores the digital data in a memory or the like in association with scanner drive signals generated by the scanner driver 25, thus generating two-dimensional image data.

Image data stored in the memory is read after a scanning period of one frame, the data that is digital is converted into analog signals, for example, standard video signals. The video signals are output to the monitor 5. In a display screen of the monitor 5, an enlarged microscope image corresponding to the observation range 12, more specifically, the cell image 5a of tissue of the sample 2 is displayed as an optical image.

According to the present embodiment with the above-mentioned structure and operation, the needle portion 11, through which the distal end 10 of the optical probe 3 can be inserted into the sample 2, is arranged at the distal end thereof. It is sure that an enlarged microscope image corresponding to the surface of the sample 2 and the vicinity thereof can be obtained. Advantageously, when the optical probe 3 is inserted into the sample 2, a microscope image of deep tissue of the sample 2 can be easily obtained.

The connector 8 of the optical probe 3 is detachably connected to the connector receptacle 9 on the main body 4. For example, another optical probe having different functions can be attached to the main body 4 and a microscope image can be obtained.

For example, an optical probe in which the diameter of a fiber optic bundle is different from that of the fiber optic bundle 7, or an optical probe in which the number of optical fibers is different from that of the fiber optic bundle 7 is prepared. Thus, a microscope image can be obtained at a resolving power or resolution suitable for observation.

If optical fibers are cut or broken due to the long time use of the optical probe 3, the optical probe 3 can be easily exchanged for another optical probe and observation can be performed using the other one.

The above description relates to the structure and operation of the system in which light from the light source 20 is converged and is applied to the sample 2, and light reflected by the sample 2 is detected. If a dichroic mirror is used instead of the half mirror 22 in the main body 4, the system can be applied to fluorescence observation.

In other words, in the fluorescence observation, the light source 20 generates light with a wavelength that causes fluorescence excitation. The light with such a wavelength is reflected and converged by the dichroic mirror. The light is then emitted toward the sample 2.

The dichroic mirror is set so that only light with a wavelength of fluorescence excited from the sample 2 transmits through the dichroic mirror. The photodetector 29 receives the transmitted light. As mentioned above, the half mirror 22 is exchanged for the dichroic mirror and a wavelength of light emitted from the light source 20 is changed to a wavelength that causes excitation light, so that fluorescence observation can be performed. In the case of the catoptric light observation, light with a substantially single wavelength can be used as light emitted from the light source 20.

As the converging optics in the distal end 10, the prism 26 and the converging lens 27 are arranged in the needle portion 11 cut obliquely in FIG. 2. Referring to FIG. 3, the prism 26 and the converging lens 27 can be arranged behind the needle portion 11.

(Second Embodiment)

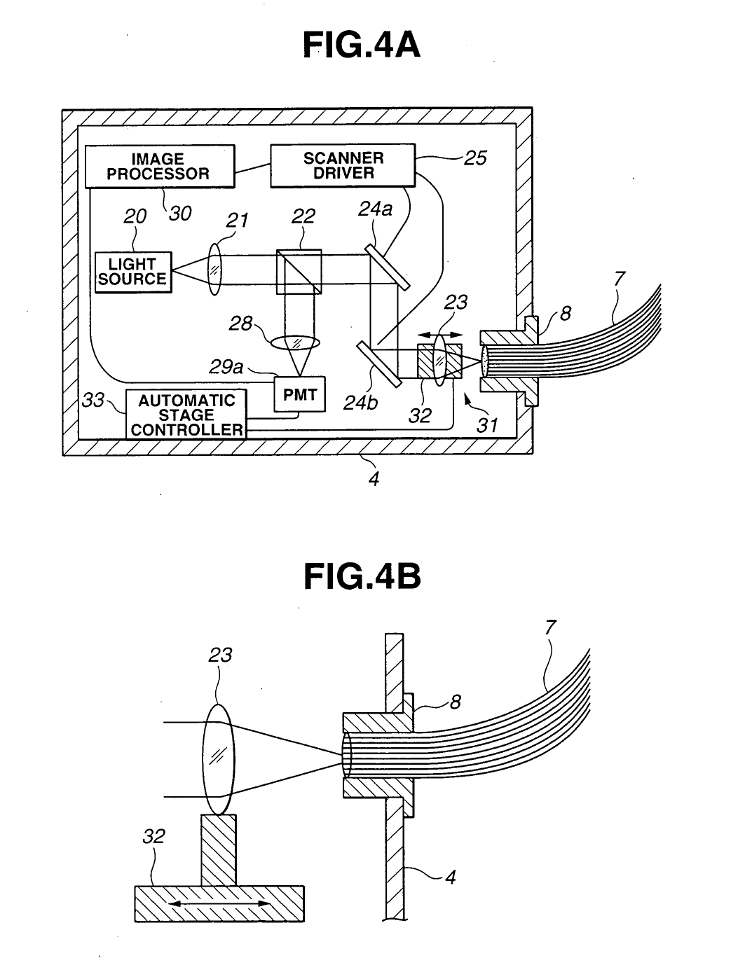

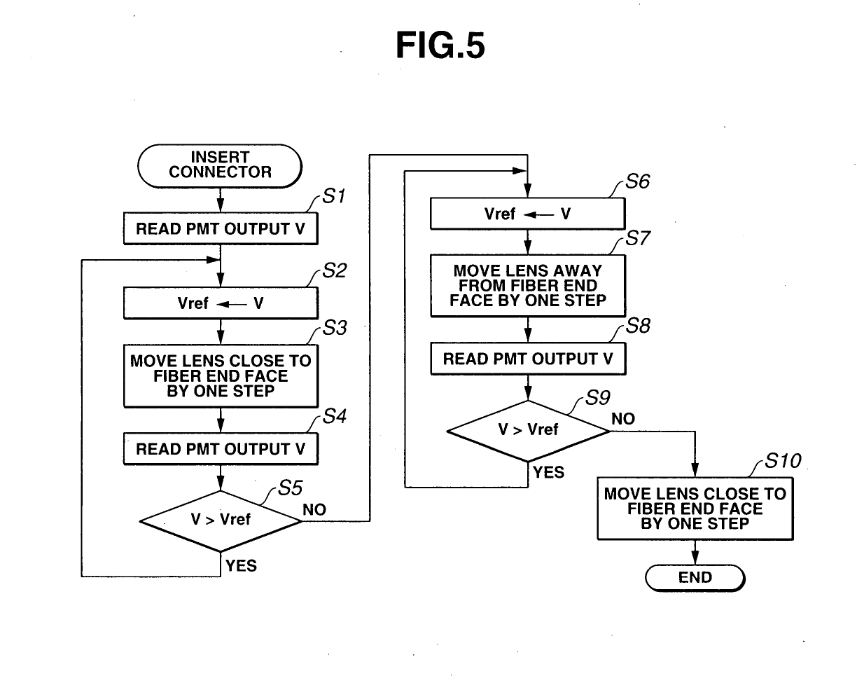

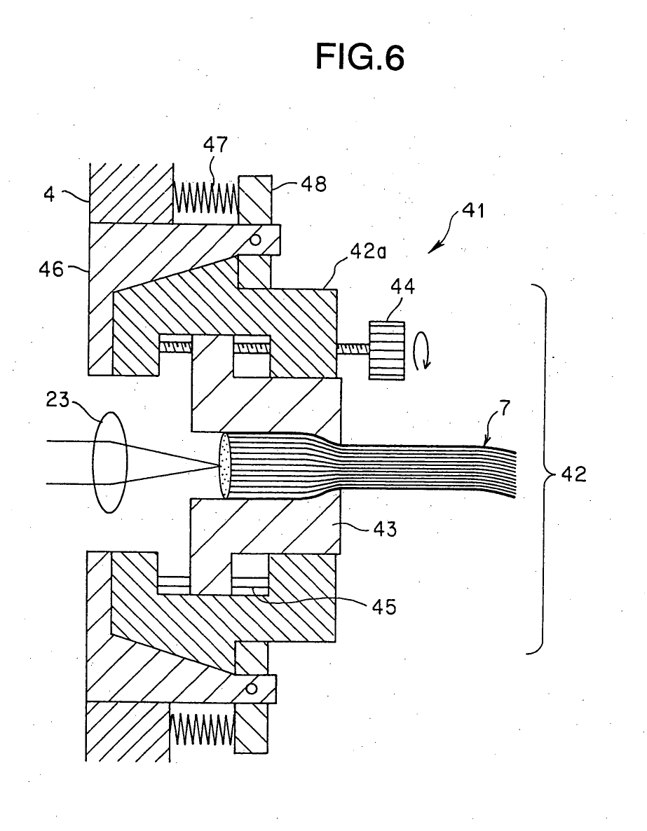

A second embodiment of the present invention will now be described hereinbelow with reference to FIGS. 4A to 10B. FIG. 4A is a block diagram showing the structure of a main body including a mechanism for adjusting the position of a lens relative to a connector according to the second embodiment. FIG. 4B is a diagram explaining the positional relation between the connector and a converging lens. FIG. 5 is a flowchart explaining the operation using an automatic stage adjustment device in FIG. 4. FIG. 6 is a diagram explaining a mechanism for manually adjusting a focal point along an optical axis.

The present embodiment relates to an embodiment having an adjustment mechanism for adjusting the connection of the connector at the proximal end of an optical probe to a proper state after the connector is attached to a main body. As will be described hereinbelow, according to the present embodiment, the adjustment mechanism is capable of adjusting the relative positional relation between the end face of the fiber bundle 7 close to a light source and light, which is emitted from the light source and is incident on the fiber bundle 7. The same components as those of the first embodiment are designated by the same reference numerals and a description of the components is omitted.

Referring to FIG. 4A, the main body 4 has an automatic adjustment mechanism 31 for adjusting the position of the converging lens 23 relative to the connector 8 detachably connected to the main body 4 to adjust the focal point of the converging lens 23 after the connector 8 is attached to the main body 4.

FIG. 4B shows an enlarged part of the mechanism. As shown in FIG. 4B, the mechanism moves the converging lens 23 along the optical axis thereof so that the proximal end face of the fiber optic bundle 7 in the attached connector 8 is positioned in the focal plane of the converging lens 23 to focus. For the sake of simplicity, the proximal end face of the fiber optic bundle 7 will be referred to as a fiber end face hereinbelow.

The structure of the main body 4 shown in FIG. 4A is substantially the same as that in FIG. 2. Referring to FIG. 4A, the converging lens 23 is disposed adjacent to the connector 8. The automatic adjustment mechanism according to the present embodiment can be similarly applied to the arrangement in FIG. 2. In the arrangement example of FIG. 4A, a photomultiplier tube (hereinbelow, abbreviated to PMT) 29a is used as a more specific example of the photodetector 29.

Referring to FIGS. 4A and 4B, according to the present embodiment, the converging lens 23 is attached to a lens stage 32 that is movable along the optical axis thereof. An automatic stage controller 33 automatically sets the position of the lens stage 32 along the optical axis.

The automatic stage controller 33 automatically adjusts the position of the lens stage 32 using an output signal of the PMT 29a.

In this case, the automatic stage controller 33 automatically adjusts the position of the lens stage 32 so that the maximum output signal of the PMT 29a is obtained as will be described with reference to FIG. 5, in other words, reflected light from the fiber end face has the highest intensity as shown in FIG. 4B.

The setting operation for automatic adjustment of the automatic stage controller 33 will now be described with reference to FIG. 5.

First, the connector 8 is inserted, namely, attached to the connector receptacle of the main body 4. Subsequently, an automatic adjustment switch (not shown) is turned on.

Then, the automatic stage controller 33 starts the automatic setting operation. As shown in step S1, in the automatic stage controller 33, a central processing unit (hereinbelow, referred to as a CPU) (not shown) reads an output V of the PMT 29a.

As shown in step S2, the CPU sets the output V to a reference output value Vref. In step S3, the CPU of the automatic stage controller 33 moves the lens stage 32, namely, the converging lens 23 toward the fiber end face by one step. After that, as shown in step S4, the CPU reads the output V of the PMT 29a.

Subsequently, in step S5, the CPU compares the output V with the reference output value Vref. For example, the CPU determines whether V>Vref. On the basis of the comparative determination, namely, if V>Vref, the operation is returned to step S2 and the same steps are repeated. On the other hand, if it is not determined that V>Vref, the operation proceeds to step S6.

In step S6, the output V is set to the reference output value Vref. Subsequently, in step S7, the CPU of the automatic stage controller 33 moves the lens stage 32, namely, the converging lens 23 away from the fiber end face by one step. After that, as shown in step S8, the CPU reads the output V of the PMT 29a.

Subsequently, in step S9, the CPU compares the output V with the reference output value Vref. For example, the CPU determines whether V>Vref. If it is determined that V>Vref, the operation is returned to step S6 and the same steps are repeated. On the other hand, if it is not determined that V>Vref, the operation proceeds to step S10.

In step S10, the CPU of the automatic stage controller 33 moves the lens stage 32, namely, the converging lens 23 toward the fiber end face by one step. After that, the automatic adjustment setting operation is terminated.

According to an automatic setting control method as shown in FIG. 5, even if the initial attachment state of the connector 8 is deviated from the focal plane in any direction, the lens stage 32 can be moved toward or away from the focal face by a very small step. Consequently, the fiber end face can be automatically set to the focal plane so that reflected light has the highest intensity.

According to the present embodiment, therefore, the operation of adjusting the fiber end face to the focal plane is not needed after the connector 8 is attached. The operability, namely, the usability can be extremely increased.

FIG. 5 explains the automatic adjustment method using the automatic stage controller 33. As shown in FIG. 6, a focusing mechanism 41 whereby focusing is manually performed can also be used.

FIG. 6 shows the focusing mechanism arranged close to a connector serving as connecting means that is detachable from the main body 4.

A connector main body 42a constituting a connector 42 has a position adjustment screw 44 for adjusting the position of a fiber holder, namely, a bundle holder 43 fixing the fiber end face along the optical axis of the converging lens 23.

For example, the fiber holder 43 fixing the fiber end face is fitted in the connector main body 42a such that it is movable along the optical axis of the converging lens 23. A rail 45 is inserted through a rail hole formed in a flange of the fiber holder 43. The position adjustment screw 44 is inserted through a screw hole formed in the flange of the fiber holder 43.

The rotation of a knob of the position adjustment screw 44 enables the movement of the fiber holder 43 in parallel to the optical axis.

The connector main body 42a is engaged with the inner surface of a connector receptacle 46, so that the connector main body 42a is positioned. The connector main body 42a is fixed to the connector receptacle 46 through a connector fixing member 48 spring-urged by springs 47.

In the arrangement of FIG. 6, the knob of the position adjustment screw 45 is rotated to move the fiber holder 43 along the optical axis of the converging lens 23. In this instance, the position of the fiber holder 43 can be adjusted so that the maximum output of the photodetector 29 or the PMT 29a is obtained.

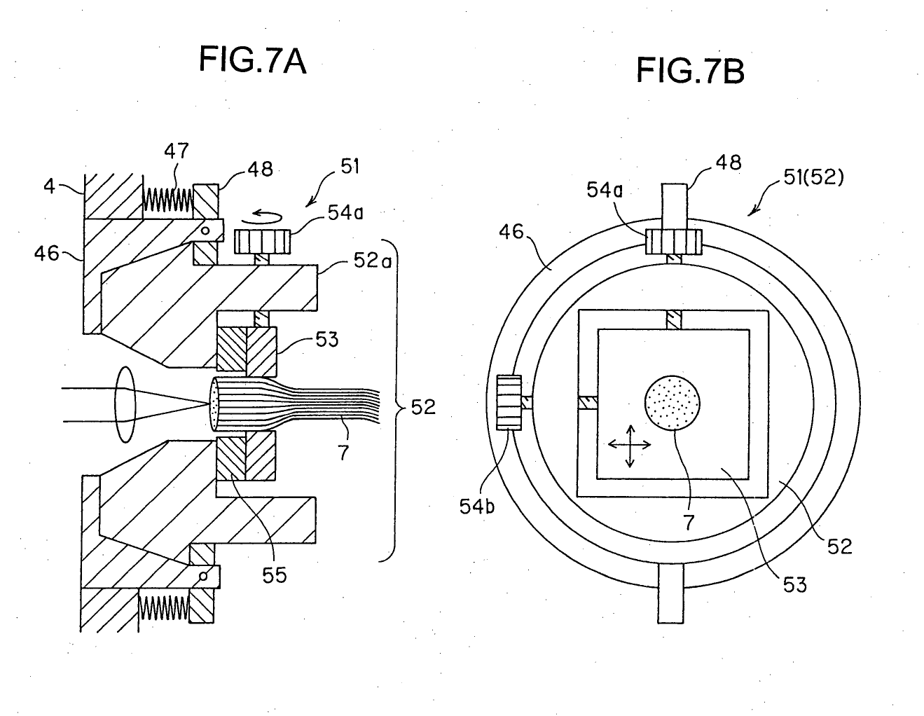

FIGS. 7A and 7B show a manual adjustment mechanism 51 in a plane perpendicular to the optical axis. FIG. 7A is a sectional view of the structure of the mechanism and FIG. 7B is a front view of the structure thereof.

In other words, FIG. 6 illustrates the adjustment mechanism along the optical axis. FIGS. 7A and 7B show the structure of the adjustment mechanism for setting the center position of the fiber end face to substantially the optical axis in the plane perpendicular to the optical axis.

Referring to FIGS. 7A and 7B, a fiber holder 53 is held by a connector main body 52a constituting a connector 52 such that the fiber end face is movable in one direction (for example, longitudinally in FIGS. 7A and 7B) in the plane orthogonal to the optical axis of the converging lens 23. The fiber holder 53 is longitudinally movable by a position adjustment screw 54a.

The fiber holder 53 is mounted on a stage 55 which is movable in the lateral direction perpendicular to the moving direction of the fiber holder 53. The stage 55 is laterally moved by a position adjustment screw 54b.

In other words, the fiber end face is movable laterally and longitudinally by the position adjustment screws 54a and 54b.

As in the case of FIG. 6, the connector main body 52a is engaged with the inner surface of the connector receptacle 46 arranged in the main body 4, so that the connector main body 52a is positioned. The connector main body 52a is fixed to the connector receptacle 46 through the connector fixing member 48 spring-urged by the springs 47.

As mentioned above, the mechanism 51 for adjusting the position in the plane is provided. Thus, even if the connector 52 is exchanged for another one and another optical probe is attached to the main body, a microscope image of a proper range can be obtained. In other words, predetermined functions can be ensured.

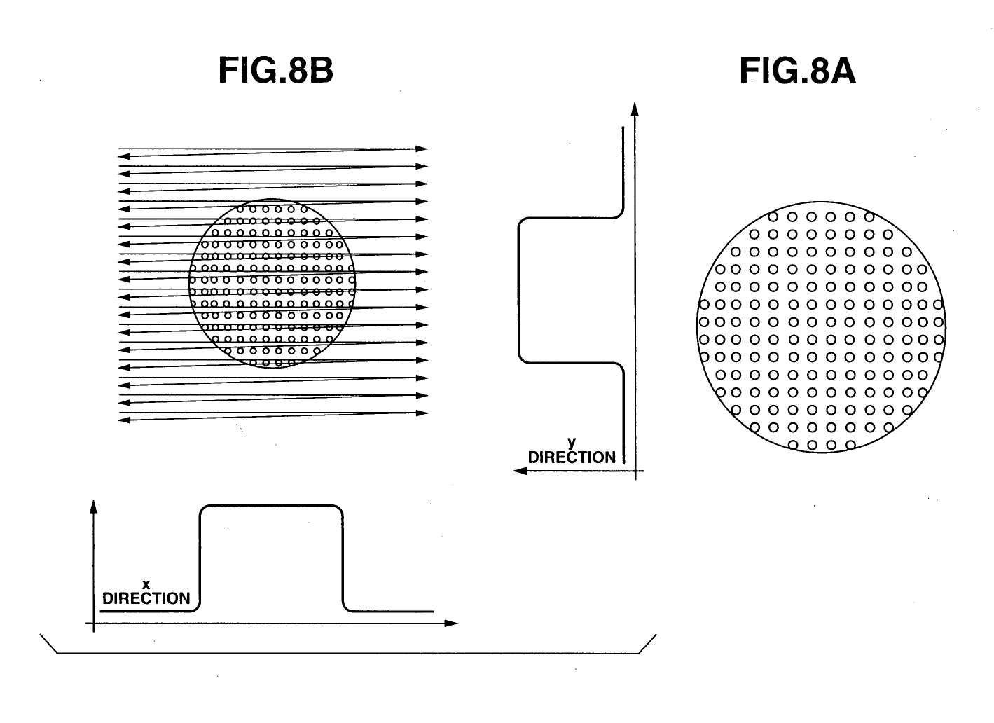

FIGS. 7A and 7B illustrate the manual adjustment mechanism 51 in the plane orthogonal to the optical axis. As shown in FIGS. 8A and 8B, electrical adjustment, more specifically, scanning adjustment can also be performed. That is, after scanning, a display range or a scanning range can be adjusted on the basis of the scanning result.

FIG. 8A is a diagram showing an array of optical fibers at the fiber end face. FIG. 8B shows optical scanning at the end face by the scan mirrors 24a and 24b and also shows a change in signal of reflected light from the fiber end face in the x and y directions in an output of the photodetector 29 in the optical scanning.

For example, referring to FIG. 2, the connector 8 is attached to the connector receptacle of the main body 4, the scanner driver 25 is operated, an output value of the photodetector 29 in this state is examined, an output of light reflected by the fiber end face is obtained, and a scanning range segment in the x direction and that in the y direction of the obtained output are examined. Thus, as shown in FIG. 8B, information regarding the scanning range in the x and y directions necessary for scanning the fiber end face can be obtained.

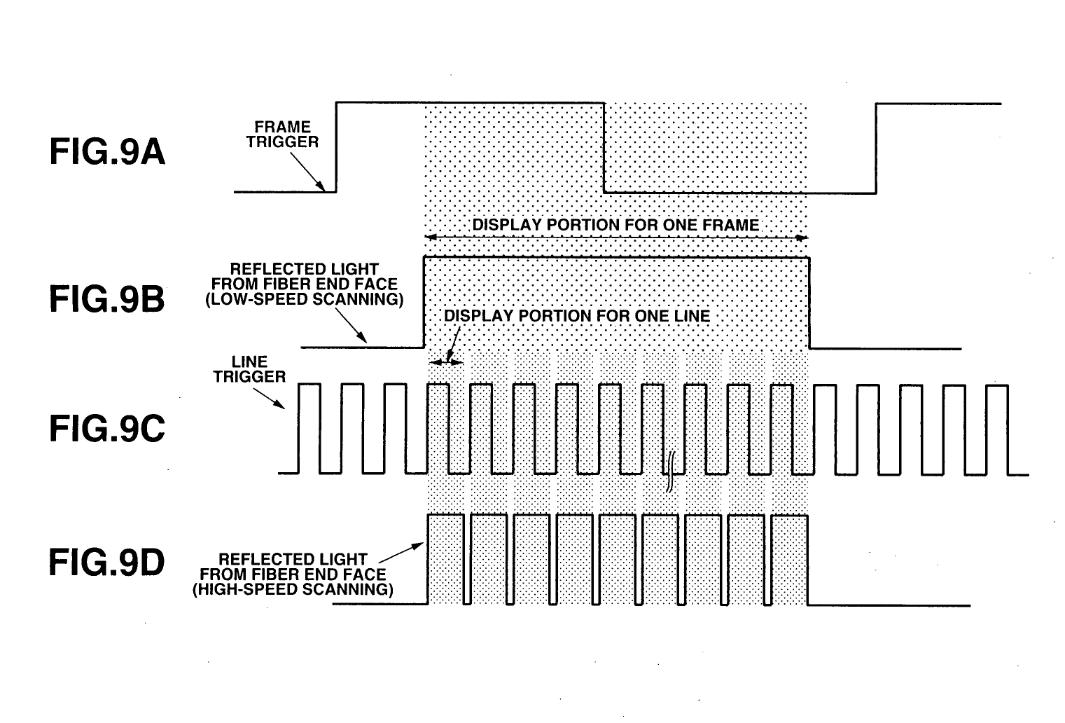

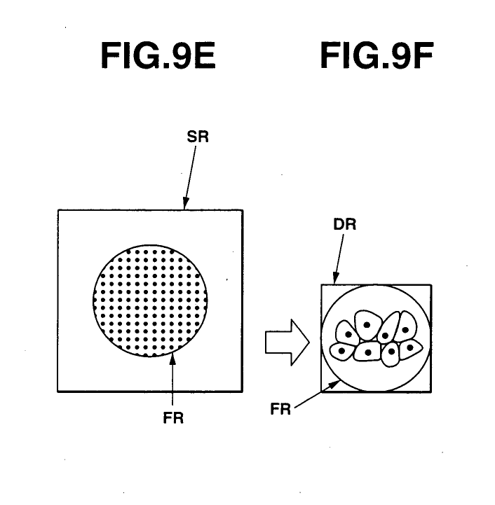

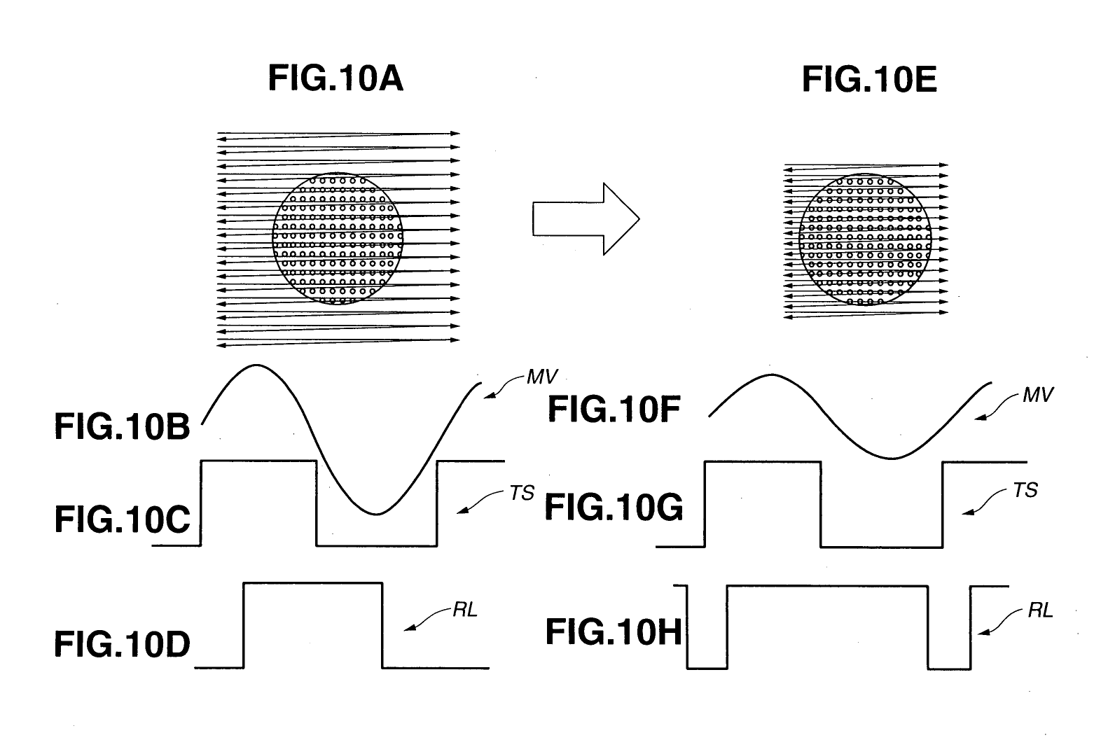

After the scanning information is obtained as mentioned above, as shown in FIGS. 9A to 9F, only a portion where the optical fibers exist, specifically, a portion including dots as shown in FIGS. 9A to 9E can be used for display. Referring to FIGS. 10A to 10H, the scanning range can be automatically adjusted to the vicinity of the portion where the optical fibers are arranged.

In this manner, position adjustment in the plane perpendicular to the optical axis can be electrically performed.

The case where only the portion corresponding to the optical fibers is used for display will now be described with reference to FIGS. 9A to 9F.

FIG. 9A shows a frame trigger signal serving as a trigger in low-speed scanning, namely, scanning in the y direction in a concrete example. Optical scanning in the y direction (low-speed scanning) is performed synchronously with this frame trigger. Referring to FIG. 9B, in this case, reflected light is detected (shown at a level H) in the portion where the fiber end face exists.

FIG. 9C shows a line trigger signal in optical scanning in the x direction (high-speed scanning). In this case, as shown in FIG. 9D, reflected light is also detected in the portion where the fiber end face exists.

In other words, referring to FIG. 9E, scanning is performed in a scanning range SR that is wider than a region FR corresponding to the fiber end face. As shown in FIG. 9F, only the range FR where reflected light is detected is displayed in a display range DR. Accordingly, position adjustment in the plane perpendicular to the optical axis can be easily performed electrically.

A method for automatically adjusting a scanning range to the vicinity of the portion corresponding to the optical fibers will now be described with reference to FIGS. 10A to 10H.

FIG. 10A is a diagram showing a scanning range obtained on condition that the connector 8 is attached, an automatic adjust button is turned on, and scanning is performed before automatic adjustment. FIG. 10B shows a vibration waveform of each mirror in the case of FIG. 10A. FIG. 10C shows a trigger signal in the case of FIG. 10A. FIG. 10D shows a signal of reflected light from the fiber end face in the case of FIG. 10A. FIG. 10E is a diagram of the scanning range after the automatic adjustment. FIG. 10F shows a vibration waveform of each mirror in the case of FIG. 10E. FIG. 10G shows a trigger signal in the case of FIG. 10E. FIG. 10H shows a signal of reflected light from the fiber end face in the case of FIG. 10E.

As in the case of FIG. 8B, scanning is performed as shown in FIG. 10A. FIG. 10B shows a vibration waveform MV of the scan mirror 24a (and 24b) in this case. FIG. 10C shows a trigger signal TS in this case. Further, FIG. 10D shows the presence or absence of detection of a reflected light signal RL.

If the range of reflected light is detected, namely, obtained, the scanning range is narrowed, namely, reduced on the basis of the range of the reflected light as shown in FIG. 10E.

Specifically, the amplitude of the vibration of each of the scan mirrors 24a and 24b is reduced so that the reflected-light detectable range occupies 90% or more of the scanning range. In other words, the amplitude of a scanner drive signal is automatically reduced so that a period of time during which reflected light is detected is equal to or longer than 90% of one period of the trigger.

As mentioned above, the amplitude of the scanner drive signal is automatically adjusted to the vicinity of the range where reflected light from the fiber end face is detected. Consequently, the operation of setting the connector 8 to a proper attachment state after attachment is not needed, resulting in an increase in usability.

As mentioned above, according to the present embodiment, focusing is performed, so that a microscope image can be obtained at a high S/N ratio. Further, since the position in the plane is adjusted, a microscope image can be obtained at a resolution corresponding to the number of optical fibers at the fiber end face. A high-quality microscope image with little aberration can also be obtained.

Since automatic adjustment is electrically performed, the user does not need adjustment, resulting in an improvement of usability. Additionally, the same advantages as those of the first embodiment are obtained.

The embodiments described in the present embodiment can also be combined with each other. In other words, the focusing position adjustment along the optical axis can be combined with the position adjustment in the plane perpendicular to the optical axis. More specifically, the lens position adjustment in FIG. 4, namely, the focusing position adjustment can be combined with the connector position adjustment in the plane in FIGS. 7A and 7B. The connector adjustment in FIG. 6 can be combined with the scanning adjustment in FIGS. 8A to 10H. The lens position adjustment in FIG. 4 can be combined with the scanning adjustment in FIGS. 8A and 8B. Further, the connector adjustment in FIG. 6 can be combined with the connector position adjustment in the plane in FIGS. 7A and 7B. Any of the above various combinations can be used.

(Third Embodiment)

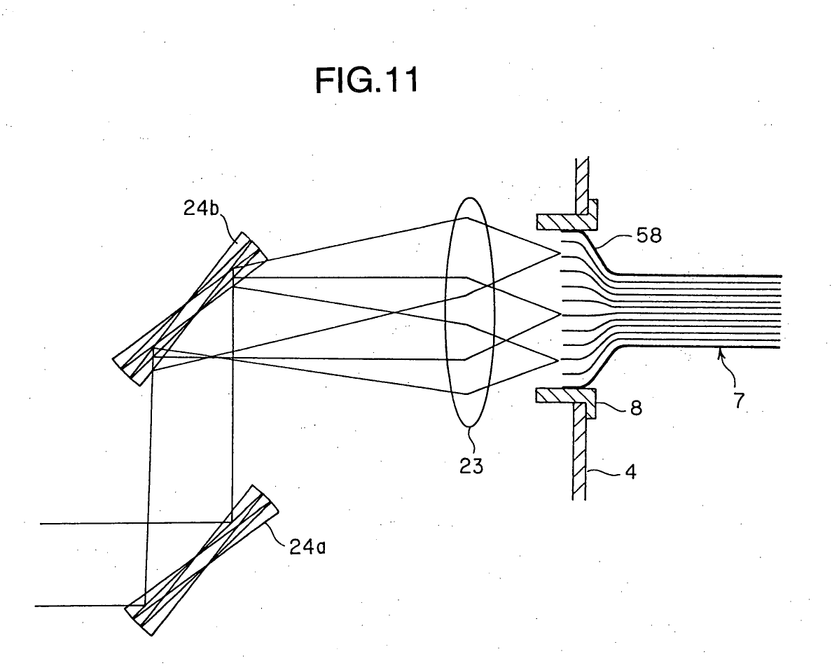

A third embodiment of the present invention will now be described with reference to FIGS. 11 to 17. FIG. 11 is a diagram showing optics in the vicinity of the connector 8 according to the present embodiment, the connector 8 being detachable from the main body 4. According to the present embodiment, the proximal end of the fiber optic bundle 7 in the connector 8, namely, the outer diameter of the bundle in the vicinity of the fiber end face is enlarged, thus forming a large-diameter portion 58.

In other words, the outer diameter of each optical fiber in the vicinity of the proximal end thereof is, for example, diverged. The outer diameter thereof at the proximal end is enlarged, so that spaces between the optical fibers are increased.

As mentioned above, the spaces between the optical fibers are increased. Consequently, on condition that light from the converging lens 23 is incident on the fiber end face, each distance between the respective cores of adjacent optical fibers at the proximal end of a probe in the vicinity of the connector is larger than that in the other portion of the probe, so that crosstalk can be suppressed. Further, simultaneously with the increase in the spaces between the optical fibers, increasing the diameter of each core results in the improvement of optical transmission efficiency.

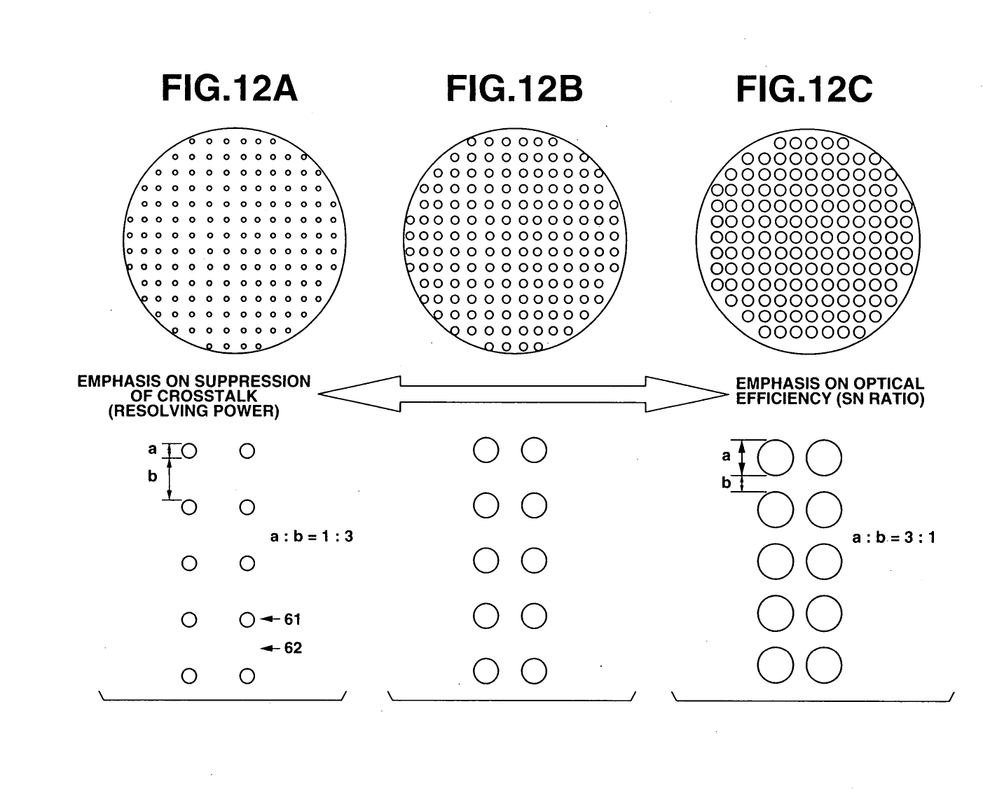

FIGS. 12A to 12C show the relation between the size of each core 61 and that of each cladding 62 in the fiber optic bundle 7 used in the present embodiment.

FIG. 12A shows the schematic relation between the size of the core 61 and that of the cladding 62 in the fiber optic bundle 7 with emphasis on crosstalk (resolving power). FIG. 12C shows the relation therebetween with emphasis on optical efficiency (S/N ratio). FIG. 12B shows the relation therebetween with emphasis on both the crosstalk and the efficiency.

Referring to FIG. 12A, a ratio of a diameter a of the core 61 to a diameter b of the cladding 62, namely, a:b is set to 1:3. Thus, the fiber optic bundle 7 is formed with emphasis on suppression of crosstalk rather than the S/N ratio.

Referring to FIG. 12C, the ratio of the diameter a of the core 61 to the diameter b of the cladding 62, namely, a:b is set to 3:1. Consequently, the fiber optic bundle 7 is formed with emphasis on an increase in S/N ratio rather than the suppression of crosstalk.

Referring to FIG. 12B, the ratio of the diameter a of the core 61 to the diameter b of the cladding 62, that is, a:b is set to an intermediate value between the value in FIG. 12A and that in FIG. 12C, namely, a value between 1:3 to 3:1 such that crosstalk can be appropriately suppressed and the proper S/N ratio can be obtained.

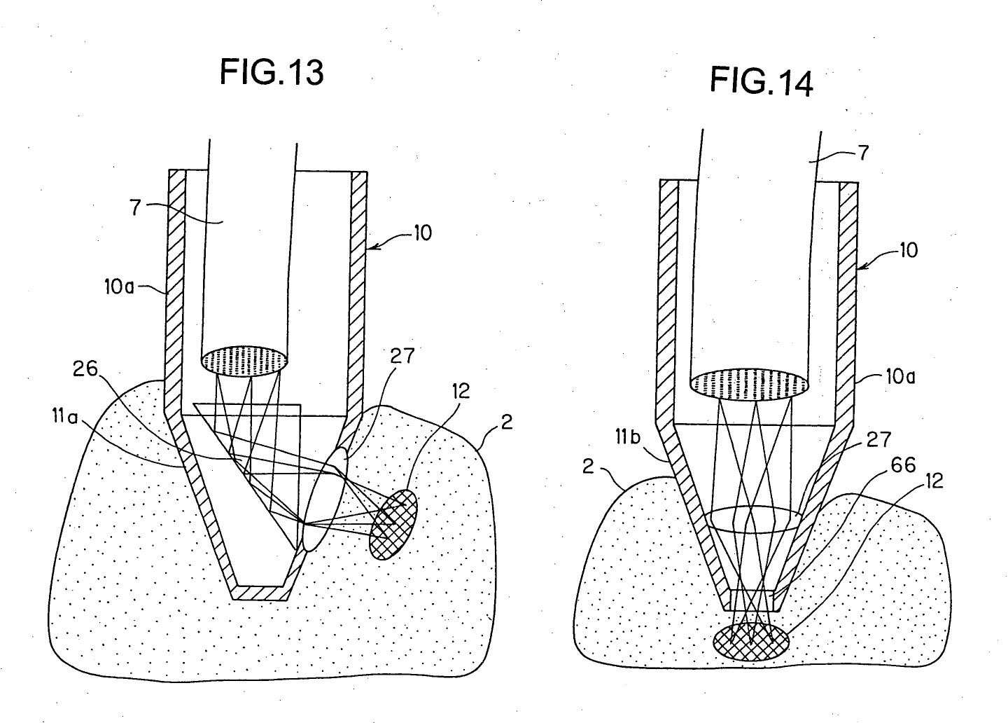

FIG. 13 is a sectional view showing the structure of the distal end 10 of the optical probe according to the third embodiment. According to the present embodiment, a needle portion 11a of the distal end 10 has, for example, a rotational symmetric shape.

In other words, the needle portion 11a is formed such that the end of the tubular member 10a is shaped into a truncated cone, an opening is formed on the side of the truncated cone, the converging lens 27 is attached to the opening such that light from the end face of the fiber optic bundle 7 is reflected by the prism 26 and is then incident on the lens, light is converged through the converging lens 27, and the converged light is applied to the observation range 12.

According to the present embodiment, the converging lens 27 is attached to the opening on the surface of the cone. The optical axis of the converging lens 27 tilts between the axis of the tubular member 10a and the direction perpendicular thereto. According to the present embodiment, the observation range 12 can be observed obliquely.

FIG. 14 is a sectional view showing the structure of the distal end 10 according to a first modification of the present embodiment.

In the present modification, a needle portion 11b of the distal end 10 has a rotational symmetric shape that is substantially the same as that in FIG. 13. According to the present modification, a direct-viewing optical probe is constructed.

In other words, light is emitted from the distal end face of the fiber optic bundle 7, fixed inside the tubular member 10a, along the axis of the tubular member 10a. The emitted light is converged by the converging lens 27, which is fixed inside the truncated cone serving as the needle portion 11b such that the optical axis of the converging lens 27 is parallel to the axis of the tubular member 10a. The converged light passes through a cover glass 66 attached to an observation window formed at the end of the truncated cone. Thus, the light is applied to the observation range 12 facing the cover glass 66. According to the present modification, observation is possible under direct vision.

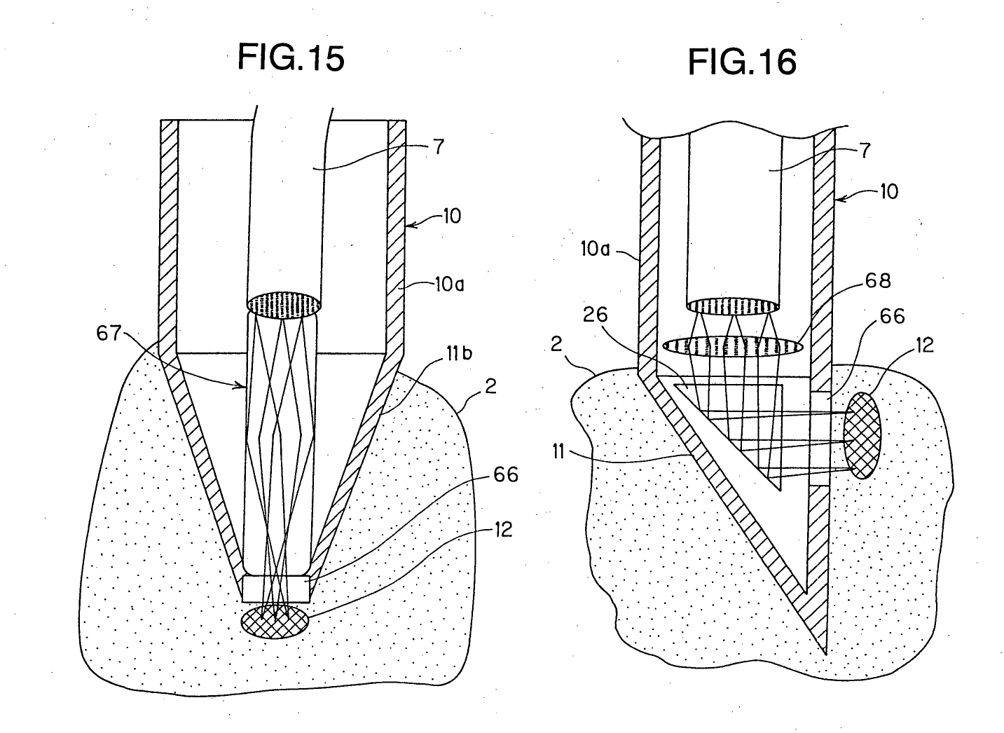

FIG. 15 is a sectional view showing the structure of the distal end 10 according to a second modification of the present embodiment. According to this modification, a GRIN lens 67 is used instead of the converging lens 27 in FIG. 14. Specifically, the GRIN lens 67 is arranged between the distal end face of the fiber optic bundle 7 and the cover glass 66 attached in the observation window.

According to the present modification, observation is also possible under direct vision. Since the GRIN lens 67 is used, the diameter can be smaller than that using the normal converging lens 27. Further, there is an advantage in that a loss in amount of light can be reduced.

FIG. 16 is a sectional view of the structure of the distal end 10 according to a third modification of the present embodiment. According to this modification, a micro-lens array 68 is arranged between the distal end face of the fiber optic bundle 7 and the prism 26 in the structure according to the first embodiment shown in FIG. 2. The converging lens 27 is not used. In other words, the cover glass 66 serving as a transparent window is attached to the opening, to which the converging lens 27 is attached in FIG. 2.

As mentioned above, the micro-lens array 68 is applied to the structure, thus suppressing an aberration at the end of the field of view in the use of the converging lens 27.

In other words, in the use of the converging lens 27, a light ray outside the range of paraxial rays causes an aberration, resulting in image degradation. However, if the micro-lens array 68 is used, the micro-lens array 68 can allow a light ray outside the range of paraxial rays to pass therethrough nearly as a paraxial ray and can function as a converging lens. Advantageously, an image with little aberration can be obtained.

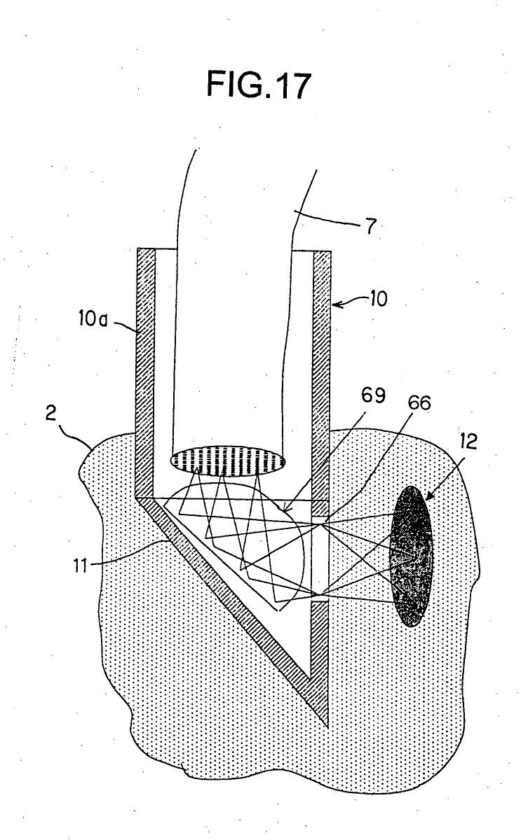

FIG. 17 is a sectional view showing the structure of the distal end 10 according to a fourth modification of the present invention. According to this modification, a prism lens 69, which has the same functions as those of the prism 26 and those of the converging lens 27, is applied to the structure in FIG. 2.

Specifically speaking, the prism lens 69 is disposed instead of the prism 26 in FIG. 2. The prism lens 69 is formed such that the surface facing the distal end face of the fiber optic bundle 26 and the surface facing the cover glass 66 are convex.

The application of the prism lens 69, serving as both of a prism and a converging lens as mentioned above, enables easier optical adjustment and assembly, resulting in a reduction in cost.

According to the present embodiment, the diameter of the fiber optic bundle in the vicinity of the connector is increased. Thus, an optical image with reduced crosstalk and/or an optical image with an increased S/N ratio can be obtained. Further, the same advantages as those of the first embodiment are obtained.

(Fourth Embodiment)

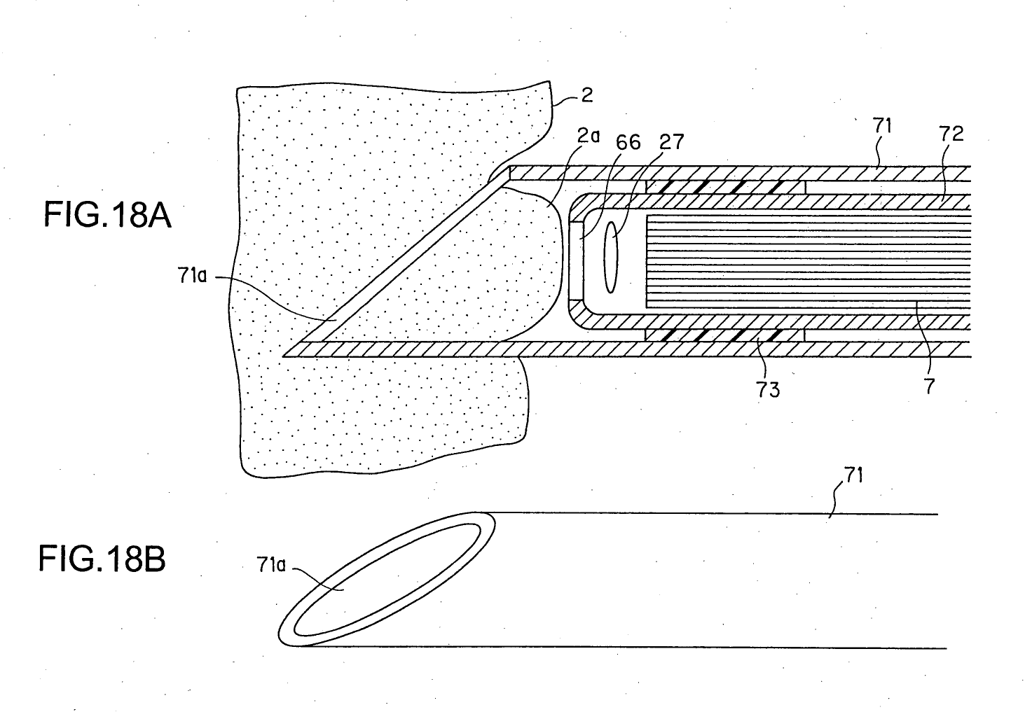

A fourth embodiment of the present invention will now be described with reference to FIGS. 18A to 20B. FIG. 18A is a sectional view of the structure of the distal end of an optical probe according to the fourth embodiment. FIG. 18B is a perspective view of a hollow needle thereof.

According to the present embodiment, the optical probe is constructed such that an inner tube 72 having therein the fiber optic bundle 7 and the converging lens 27 is arranged in a hollow needle 71 and nearly the distal end of the inner tube 72 is held by a z-directional actuator 73 for moving a portion in the vicinity of the distal end of the inner tube 72 forward or backward in the z direction (along the axis of the fiber optic bundle 7).

The cylindrical inner tube 72 functions as a direct-viewing probe hermetically constructed such that an opening is formed at the distal end of the inner tube 72 and the cover glass 66 is attached to the opening.

The distal end of the hollow needle 71 is obliquely cut to form an opening 71a. Referring to FIG. 18A, the hollow needle 71 is inserted into the sample 2, so that tissue 2a of the sample 2 enters the opening 71a.

The tissue entered the opening 71a can be observed through the probe in the inner tube 72. In this instance, the inner tube 72 is movable forward or backward in the z direction by the z-directional actuator 73, thus adjusting an observation range in the z direction.

According to the present embodiment, a microscope image such as a cell image of tissue, entered the hollow needle 71, can be obtained. Further, microscope images with different in-depth positions can be obtained by the z-directional actuator 73.

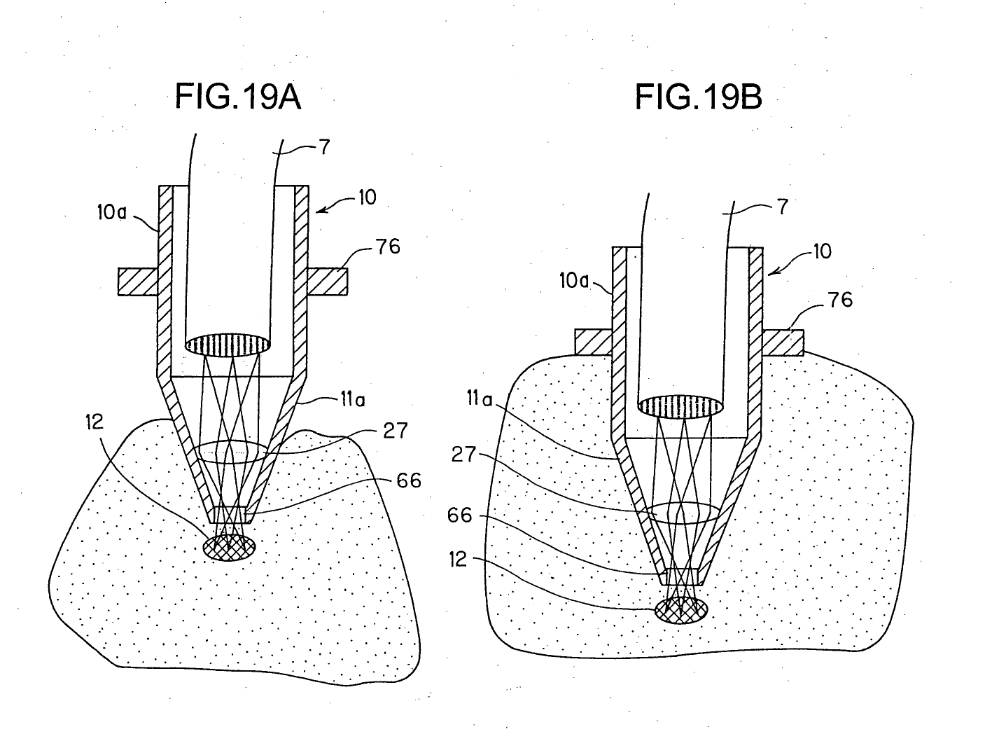

FIG. 19A is a sectional view of the structure of the distal end of the optical probe 10 according to a first modification of the present embodiment. FIG. 19B is a sectional view explaining a state of the needle portion 11a inserted in the sample 2. This optical probe 10 is formed by further providing a protrusion 76 for the distal end 10 of the optical probe in FIG. 13.

In other words, the tubular member 10a has the protrusion 76, which protrudes in the direction perpendicular to the axis of the tubular member 10a. Referring to FIG. 19B, the protrusion 76 functions as insertion-depth limiting means for limiting the depth of insertion of the needle portion 11a in the sample 2 so that the needle portion 11a is not further inserted thereinto.

According to the present modification, in observation while the distal end of the optical probe is inserted in the sample, advantageously, the insertion to the extent that is not intended can be prevented.

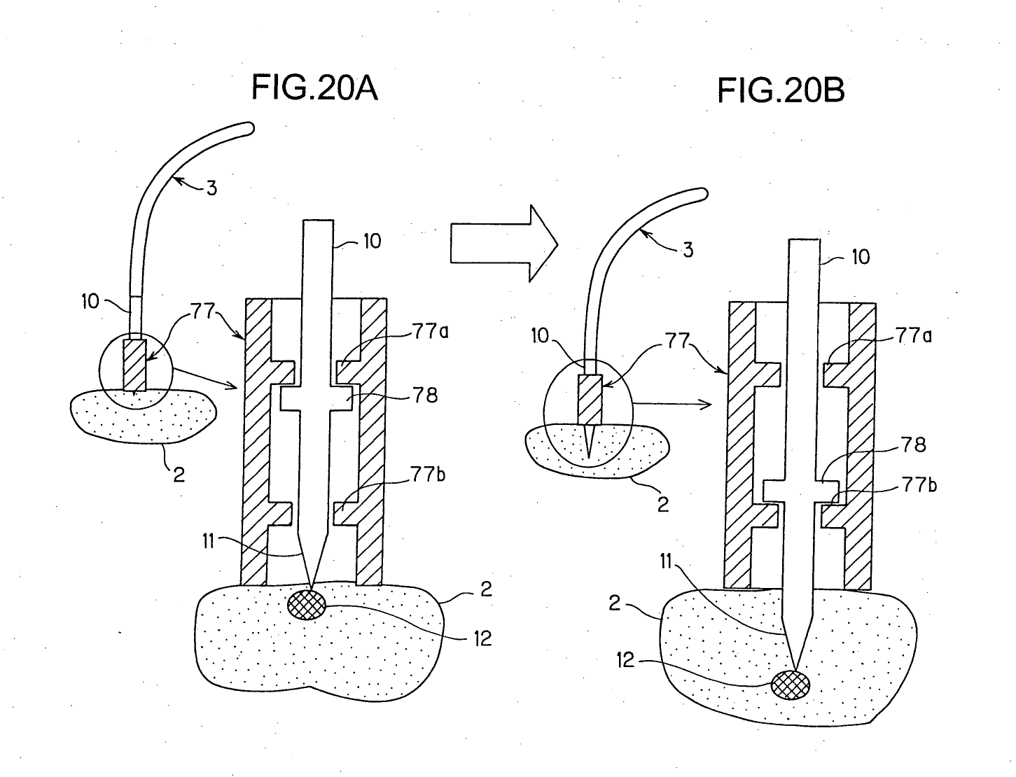

FIGS. 20A and 20B are diagrams explaining the structure of the distal end of the optical probe 3 according to a second modification of the present embodiment.

The optical probe 3 has an observation-depth limiting member 77 that is detachable from the distal end thereof.

As in the case shown in FIGS. 19A and 19B, the distal end 10 of the optical probe has a protrusion 78. The observation-depth limiting member 77 is arranged such that it covers the distal end 10.

The observation-depth limiting member 77 has a nearly cylindrical shape. On the inner surface of the member 77, two fitting protrusions 77a and 77b are arranged in the longitudinal direction. The inner diameter of each of the fitting protrusions 77a and 77b is smaller than the outer diameter of the protrusion 78. The protrusion 78 is movable between the fitting protrusions 77a and 77b.

Referring to FIG. 20A, when the observation-depth limiting member 77 arranged at the distal end of the optical probe 10 is set such that the end face thereof comes into contact with the surface of the sample 2, the protrusion 78 comes into contact with the fitting protrusion 77a. In this state, the distal end of the needle portion 11 of the optical probe is positioned close to the surface of the sample 2. At this time, the observation range 12 includes the surface.

To observe a deep part, the needle portion 11 is inserted into the sample 2. Thus, the inside of the sample 2 can be obtained as the observation range 12. In deep insertion, as shown in FIG. 20B, the protrusion 78 comes into contact with the fitting protrusion 77b. Thus, the protrusion 78 is limited so that the distal end 10 cannot be inserted deeper.

In other words, the fitting protrusion 77b can prevent deeper insertion. That is, the insertion to the extent that is not intended in observation can be prevented.

(Fifth Embodiment)

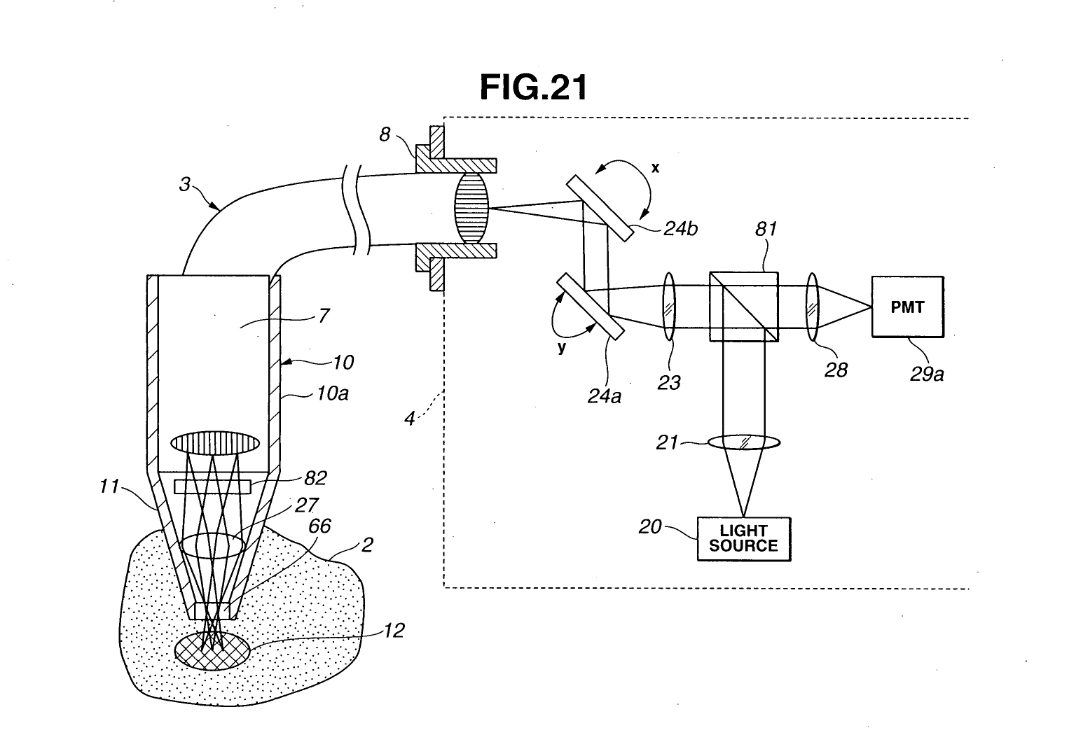

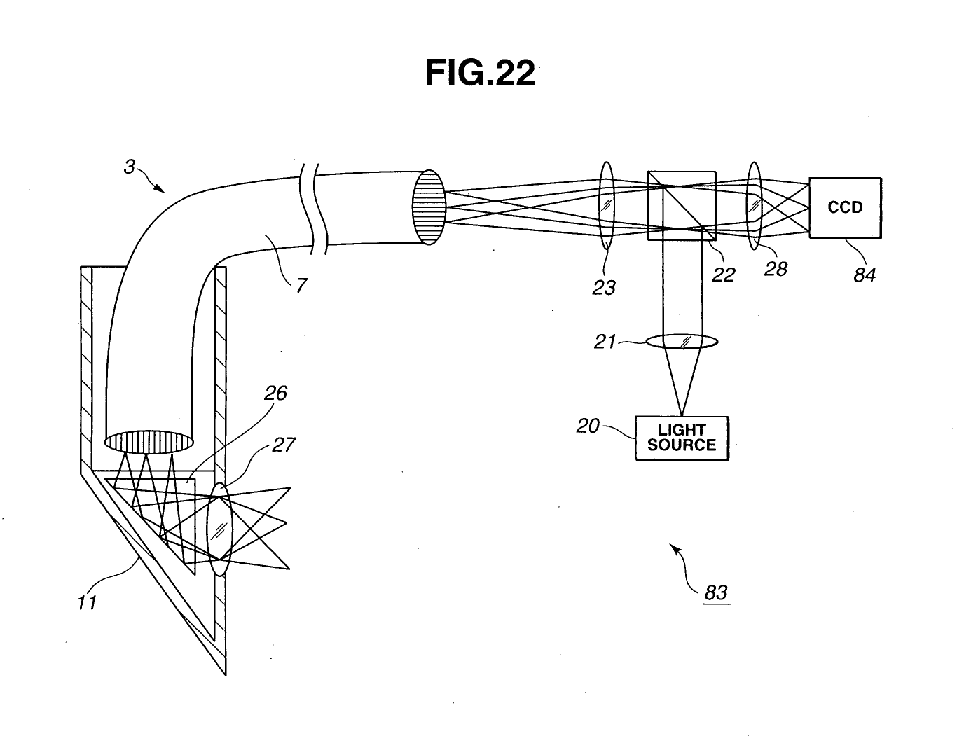

A fifth embodiment of the present invention will now be described with reference to FIGS. 21 and 22. FIG. 21 is a diagram showing the structure of the optical probe 3 and optics in the main body 4 according to the fifth embodiment.

The main body 4 according to the present embodiment includes a polarizing beam splitter (hereinbelow, abbreviated to PBS) 81 instead of the half mirror 22 in the optics in the main body 4 shown in FIG. 2.

The light source 20 generates s-polarized light. The s-polarized light is incident on the PBS 81. Nearly 100% of this light is reflected by the PBS 81. P-polarized light passes through the PBS 81.

According to the present embodiment, the optical probe 3 is constructed such that a ¼ wave plate 82 is arranged, for example, between the distal end face of the fiber optic bundle 7 and the converging lens 27 in the optical probe 3 in FIG. 14.

The other components are the same as those of the first embodiment. According to the present embodiment, assuming that light reflected by the PBS 82 is reflected through the scan mirrors 24a and 24b such that it is converged and applied to the proximal end face of the fiber optic bundle 7 of the optical probe 3, if the light is reflected by the proximal end face, it does not pass through the PBS 81. Therefore, the reflected light can be controlled so as not to be incident on the photodetector, namely, the PMT 29a in this case. Thus, the S/N ratio can be increased.

For the s-polarized light emitted from the distal end face of the fiber optic bundle 7, the light passes through the ¼ wave plate 82 to produce circularly polarized light. Light reflected from the sample 2 passes through the ¼ wave plate 82 to produce p-polarized light. Nearly 100% of this light passes through the PBS 81. Then, the light is received by the PMT 29a.

According to the present embodiment, only signal components of light can be efficiently used, thus increasing the S/N ratio.

FIG. 22 is a diagram showing essential parts, namely, optics in a main body of an optical imaging system 83 and an optical probe according to a modification of the present embodiment. According to the present modification, the main body 4 does not include optical scanning means that is provided in the main body 4 in FIG. 2 or the like.

Specifically speaking, referring to FIG. 2, the scan mirrors 24a and 24b are arranged between the converging lens 23 and the proximal end face of the fiber optic bundle 7 of the optical probe 3. According to the present modification, the scan mirrors 24a and 24b are eliminated. An image pickup device, for example, a CCD 84 is disposed at a position where an image is formed by the converging lens 28.

In this case, the converging lenses 23 and 28 are arranged such that the proximal end face of the fiber optic bundle 7 and the image pickup surface of the CCD 84 are conjugate focal points. Light of the light source 20 is set such that it is incident on the whole proximal end face of the fiber optic bundle 7. Specifically speaking, the light source 20 is arranged close to the collimator lens 21 such that it is slightly closer to the collimator lens 21 than the focal point of the collimator lens 21.

The optical probe 3 has the same structure as that of, for example, the optical probe 3 in FIG. 2. The other components are the same as those of the first embodiment.

According to the present embodiment, optical scanning means is not needed. Thus, the structure can be simplified, resulting in a reduction in cost.

Referring to FIG. 22, using a dichroic mirror instead of the half mirror 22 enables fluorescence observation.

(Sixth Embodiment)

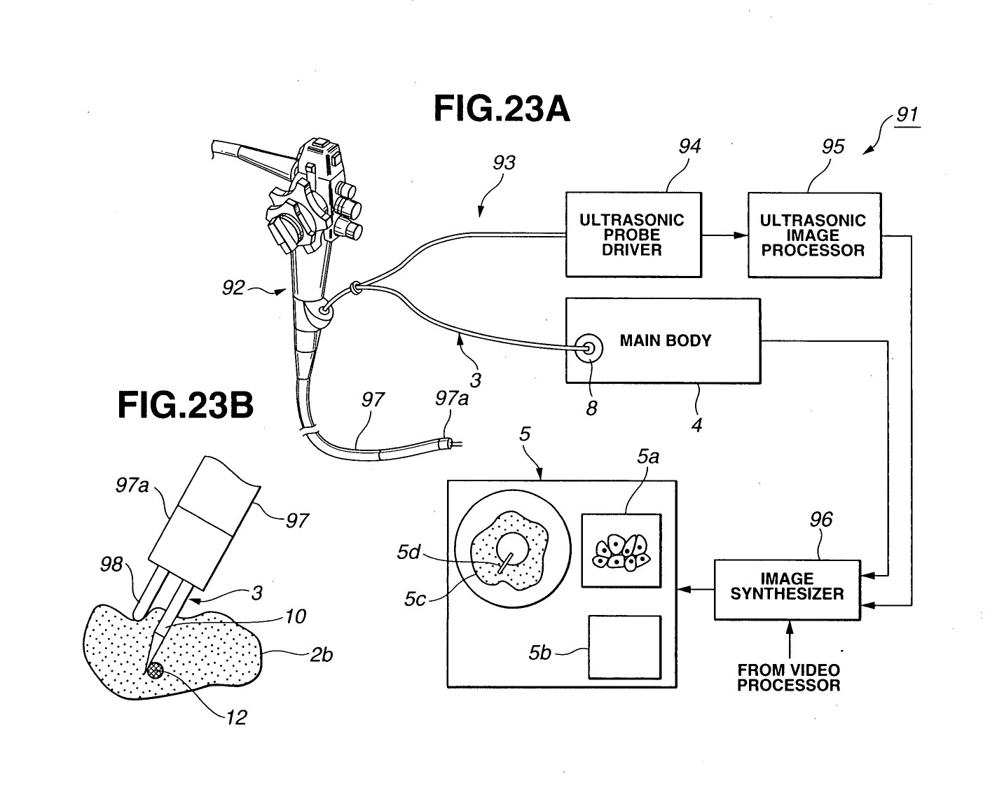

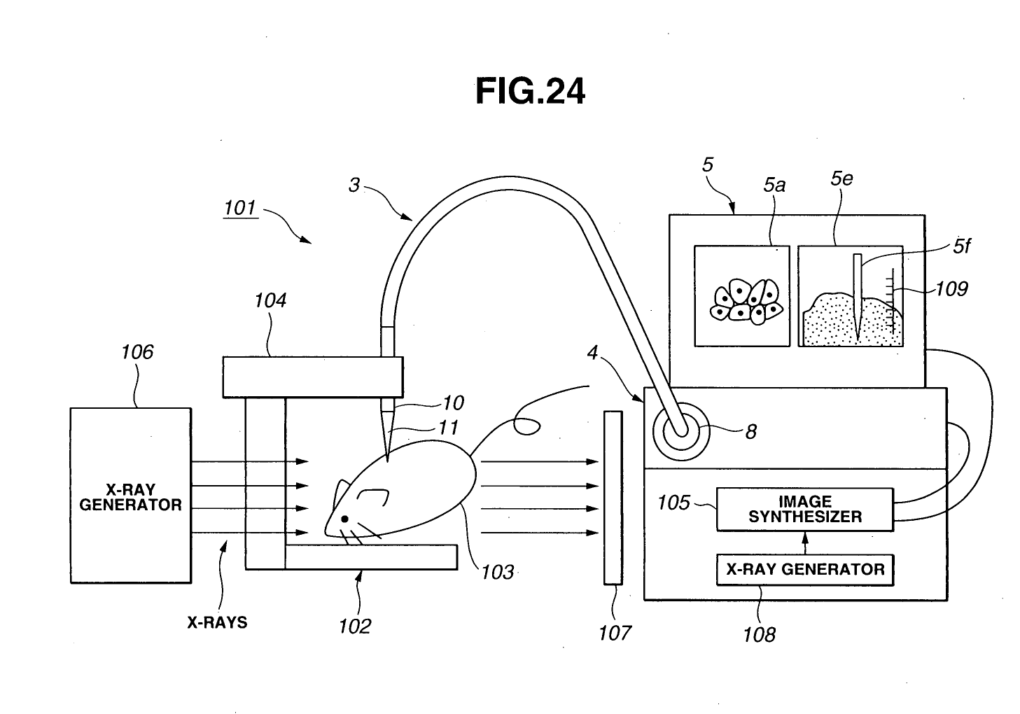

A sixth embodiment of the present invention will now be described with reference to FIGS. 23A, 23B, and 24. FIG. 23A is a diagram showing the structure of an optical imaging system 91 according to the sixth embodiment. FIG. 23B is a diagram explaining the vicinity of the distal end of an endoscope in a use example.

Referring to FIG. 23A, the present optical imaging system 91 serves as an optical imaging system for obtaining a confocal microscope image as an optical image using the optical probe 3, for example, a cell image in this case. Further, the present system can combine images, obtained through different kinds of image obtaining means, to display the combined images.

Referring to FIG. 23A, the optical imaging system 91 includes the optical probe 3, the main body 4, the monitor 5, an endoscope 92 having a channel through which the optical probe 3 is arranged, an ultrasonic probe 93 which is disposed in the channel together with the optical probe 3, an ultrasonic probe driver 94 for driving the ultrasonic probe 93, an ultrasonic image processor 95 for processing ultrasonic echo signals from the ultrasonic probe 93 to generate an ultrasonic image, and an image synthesizer 96 for combining an optical image generated from the main body 4 with an ultrasonic image generated from the ultrasonic image processor 95.

The present system further includes a video processor for processing image pickup signals, obtained by an image pickup device in the endoscope 92, to generate video signals of an endoscope image. The endoscope image is also supplied from the video processor to the image synthesizer 96.

Referring to FIG. 23B, a distal end 97a of an insertion portion 97 of the endoscope 92 inserted into a body cavity is close to a subject part 2b in the body cavity. Under observation using the endoscope 92, the distal end 10 of the optical probe 3 protruded from the distal end of the channel is inserted into the subject part 2b. Thus, the cell image 5a in the observation range 12 can be obtained. Further, an ultrasonic container 98 housing an ultrasonic vibrator at the distal end of the ultrasonic probe 93 is thrust on the surface of the subject part 2b, thus obtaining an ultrasonic image including an inserted portion in the subject part 2b in the vicinity of the distal end of the optical probe 3 (a probe distal-end image 5d in the monitor 5).

Accordingly, as shown in FIG. 23A, an endoscope image 5b, the cell image 5a, and an ultrasonic image 5c can be combined and displayed in the monitor 5. In the ultrasonic image 5c, the probe image 5d of the distal end of the optical probe 3 can be seen as a needle.

According to the present embodiment, not only the cell image 5a, but also the endoscope image 5b and the ultrasonic image 5c can be displayed. Thus, diagnosis for an observation target part can be easily conducted more comprehensively. The insertion state of the distal end 10 of the optical probe 3 can be easily confirmed.

FIG. 24 shows an optical imaging system 101 according to a modification of the present embodiment. This optical imaging system 101 has X-ray image generating means, in addition to the optical imaging system comprising the optical probe 3, the main body 4, and the monitor 5.

Referring to FIG. 24, in the optical imaging system 101, for example, a rat 103 serving as a sample is put on a laboratory stage 102. The end of the needle portion 11 at the distal end 10 of the optical probe 3 is inserted into the rat 103. The distal end 10 of the optical probe 3 is fixed by a probe fixing tool 104 arranged above the laboratory stage 102.

The optical probe 3 is connected to the main body 4. The main body 4 is connected to the monitor 5 through an image synthesizer 105. The cell image 5a is displayed on the display screen of the monitor 5.

An X-ray generator 106 for generating X-rays and an X-ray detector 107 for detecting the X-rays are arranged such that the laboratory stage 102 is sandwiched therebetween. X-rays from the X-ray generator 106 are applied to the rat 103 and are then detected by the X-ray detector 107.

The detected X-rays are converted into electric signals by the X-ray detector 107. The electric signals are supplied to an X-ray image generator 108, so that video signals of an X-ray image are generated. The X-ray image is supplied to the image synthesizer 105. Thus, an X-ray image 5e is displayed together with the cell image 5a in the display screen of the monitor 5.

Referring to FIG. 24, the X-ray image 5e displayed in the monitor 5 includes an X-ray image of the rat 103 and an image 5f of the distal end of the optical probe 3 inserted in the rat 103. In the display screen of the monitor 5, a scale 109 for indicating the depth of insertion of the distal end of the optical probe 3 is displayed or arranged. The scale 109 serves as insertion-depth indicating means whereby the approximate depth of insertion is easily known.

According to the present embodiment, the same advantages as those of the case in FIG. 23 are obtained.

Further, an optical computed tomography (CT) device can be used as image obtaining means such as the X-ray detector 107, which is used in addition to image obtaining means for obtaining a confocal microscope image using the optical probe 3. Alternatively, a CCD can be arranged in a position where an image is formed by a general optical microscope. An optical CT image obtained by the optical CT device or a microscope image obtained by the CCD can be displayed in the common monitor 5 through image synthesizing means.

According to the above-mentioned embodiments, the optical probe is detachable from the main body 4 including the light source 20, light detecting means, and image generating means. The arrangement is not limited to it. For example, the optical probe is detachable from the main body 4, which is separated from the image generating means. Further, the optical probe is detachable from the main body, which is separated from the light detecting means and the image generating means. Additionally, the optical probe is detachable from the main body 4 including at least one of the light source 20, the light detecting means and the image generating means.

The present invention also includes other embodiments obtained by partially combining the above-mentioned embodiments.

As described above, according to the above-mentioned embodiments, a needle portion is inserted into a sample, so that a microscope image of an inner portion of the sample can be obtained.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An optical imaging system comprising:
a light source for emitting light to a sample;
a small-diameter probe;
a fiber optic bundle, arranged in the probe, for guiding light from the light source to the sample;
light detecting means for detecting light reflected by the sample;
image generating means for generating an image on the basis of signals obtained by the light detecting means;
connecting means for detachably connecting the probe to at least one of the light source, the light detecting means, and the image generating means; and
position adjusting means for adjusting the relative positional relation between the end face of the fiber bundle close to the light source and light, which is emitted from the light source and is incident on the fiber bundle.

2. The system according to claim 1, wherein the position adjusting means is arranged inside the connecting means.

3. The system according to claim 1, further comprising:
automatic control means for automatically controlling the position adjusting means.

4. The system according to claim 1, further comprising:
first converging means, arranged between the end face of the fiber optic bundle close to the light source and the light source, for converging the light from the light source to the fiber bundle, wherein
the position adjusting means adjusts the relative positional relation between the first converging means and the end face of the fiber optic bundle close to the light source.

5. The system according to claim 4, wherein the position adjusting means adjusts the position of the first converging means.

6. An optical imaging system comprising:
a light source for emitting light to a sample;
a small-diameter probe;
a fiber optic bundle, arranged in the probe, for guiding light from the light source to the sample;
light detecting means for detecting light reflected by the sample;
image generating means for generating an image on the basis of signals obtained by the light detecting means;
a needle portion at the distal end of the probe with which the distal end of the probe is insertable into the sample; and
connecting means for detachably connecting the probe to at least one of the light source, the light detecting means, and the image generating means.

7. The system according to claim 6, further comprising:
position adjusting means for adjusting the relative positional relation between the end face of the fiber bundle close to the light source and light, which is emitted from the light source and is incident on the fiber bundle.

8. The system according to claim 7, wherein the position adjusting means is arranged inside the connecting means.

9. The system according to claim 7, further comprising:
automatic control means for automatically controlling the position adjusting means.

10. The system according to claim 7, further comprising:
first converging means, arranged between the end face of the fiber optic bundle close to the light source and the light source, for converging the light from the light source to the fiber bundle, wherein
the position adjusting means adjusts the relative positional relation between the first converging means and the end face of the fiber optic bundle close to the light source.

11. The system according to claim 10, wherein the position adjusting means adjusts the position of the first converging means.
